(19) United States
(12) Patent Application Publication
(10) Pub. No.: US 2007/0178238 A1
(43) Pub. Date: Aug. 2, 2007

(54) Manufacturing method for coating liquid for plate with coating having phase retardation, manufacturing method for plate with coating having phase retardation, and manufacturing method for compound polarizing plate

(75) Inventors: Kenji Yamada, Niihama-shi (JP); Yuichiro Kunai, Niihama-shi (JP); Tohru Nagashima, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/492,778

(22) Filed: Jul. 26, 2006

(30) Foreign Application Priority Data
Aug. 2, 2005 (JP) 2005-223773

(51) Int. Cl. B05D 3/02

(52) U.S. Cl. 427/384

(57) ABSTRACT

A coating liquid for a plate with a coating having phase retardation which can keep the adhesiveness high when a plate with a coating having phase retardation that includes an organic modified clay complex is pasted to liquid crystal cell glass is manufactured. In the manufacture of a coating liquid by mixing an organic solvent, an organic modified clay complex and a binder resin, an organic solvent, an organic modified clay complex and a binder resin are mixed, and furthermore, an adsorbent which can remove impurities included in the mixture is added for processing, and thereby, a coating liquid for a plate with a coating having phase difference is manufactured. This coating liquid is applied to a base and dried, and thus, a plate with a coating having phase retardation is manufactured, and in addition, a polarizing plate 11 having an adhesive layer 12 is pasted to a plate with a coating having phase retardation 15 that has been formed on a transfer base 20, in such a manner that the adhesive layer side of the polarizing plate makes contact with the exposed surface of the plate with a coating having phase retardation, and then, the transfer base 20 is removed from the plate with a coating having phase retardation 15, and thereby, a compound polarizing plate is manufactured.

### BACKGROUND OF THE INVENTION

1. Field of the Invention

The present invention relates to a manufacturing method for a coating liquid that is used for the manufacture of a plate with a coating having phase retardation that is effective for improving the view angle properties of liquid crystal displays, a manufacturing method for such a plate with a coating having phase retardation, and a manufacturing method for a compound polarizing plate where a polarizing plate is layered on this plate with a coating having phase retardation.

2. Description of the Related Art

In recent years, thin, lightweight type liquid crystal displays having low power consumption and drive at a low voltage have been spreading rapidly as display devices for information, such as cellular phones, portable information terminals, computer monitors and television sets. As liquid crystal technology has been progressing, liquid crystal displays of various modes have been proposed, and thus, problems with liquid crystal displays, such as low speed of response, little contrast and a small view angle have been resolved. However, it has been pointed out that the view angle is still small in comparison with cathode ray tubes (CRT's), and various attempts have been made to widen the view angle.

A nematic type liquid crystal display in vertical orientation mode (VA-LCD) has been developed that as one liquid crystal display system to improve these view angle properties is disclosed in, for example, Japanese Patent No. 2548979. In this vertical orientation mode, liquid crystal molecules are oriented vertically from the substrate in a non-driven state, and therefore, light transmits through the liquid crystal layer without changing in polarization. Therefore, an almost completely black display can be gained when viewed from the front, by placing linear polarizing plates above and below the liquid crystal panel so that the polarizing axes cross perpendicularly to each other, and a high contrast ratio can be provided.

In a liquid crystal display in vertical orientation mode where only polarizing plates are provided with liquid crystal cells in the above described manner, however, the angle between the axes of the placed polarizing plates shifts from 90° when viewed diagonally, and liquid crystal molecules in rod form within the cells exhibit birefringence, causing light leakage and significantly lowering the contrast ratio.

In order to solve such light leakage, it is necessary to place an optical compensation film between the liquid crystal cells and linear polarizing plates, and conventional specifications where one plate having biaxial phase retardation is placed in each gap between liquid crystal cells and the upper and lower polarizing plate, one plate having uniaxial phase retardation and one plate having complete biaxial phase retardation are placed above and below the liquid crystal cells, and two plates are placed on one side of the liquid crystal cells have been adopted. JP 2001-109009A (Claim 15 and paragraph 0036), for example, discloses that an a-plate (that is to say, a plate having positive uniaxial phase retardation) and a c-plate (that is to say, a plate having completely biaxial phase retardation) are respectively placed between upper and lower polarizing plates and liquid crystal cells in a liquid crystal display in vertical orientation mode.

A plate having positive uniaxial phase retardation is a film where the ratio R₀/R′ of phase retardation value R₀ within a plane to phase retardation value R′ in the direction of the thickness is approximately 2, and a plate having completely biaxial phase retardation is a film where phase retardation value R₀ within a plane is approximately 0. Here, when the index of refraction in the direction of the delay phase axis within the plane of the film is nₓ, the index of refraction in the direction of the fast phase within the plane of the film (direction perpendicular to the direction of the delay phase axis) is n_{y}, the index of refraction in the direction of the thickness of the film is n_{z}, and the thickness of the film is d, phase retardation value R₀ within the plane and phase retardation value R′ in the direction of the thickness are respectively defined by the following formulas (I) and (II).
R₀=(nₓ−n_{y})×d (I)
R′=[(nₓ+n_{y})/2−n_{z}]×d (II)

In the case of a positive uniaxial film, n_{z}^{˜}n_{y}, and therefore, R₀/R′^{˜}2. Even in the case of a uniaxial film, R₀/R′ varies between approximately 1.8 and 2.2, due to fluctuation of the conditions for stretching. In the case of a completely biaxial film, nₓ^{˜}n_{y}, and therefore, R₀^{˜}0. In a completely biaxial film, only the index of refraction is different (is smaller) in the direction of the thickness, and therefore, has negative uniaxial properties and may be said to be a film of which the optical axis is in the direction of the normal, and in addition, may be referred to as a c-plate, as described above. In the biaxial film, nₓ>n_{y}>n_{z}.

JP 10-104428A (=U.S. Pat. No. 6,060,183) discloses formation of a plate having phase retardation of a coating layer which includes an organic decorative clay complex which can be dispersed in an organic solvent as a completely biaxial plate having phase retardation for use for the above described purpose. The configuration of a compound polarizing plate where a plate having phase retardation made of a coating layer as that described above is layered on a polarizing plate in a predetermined form is simplified, and when this compound polarizing plate is applied to a liquid crystal display, excellent view angle properties and simplicity can both be provided. In addition, Japanese Unexamined Patent Publication No. 2004-294983 discloses a type of polarizing plate that is integrated with a plate having phase retardation where an organic modified clay complex which can be dispersed in an organic solvent and a plate having phase retardation made of a layer of composition containing a (meth)acryl based resin are provided on one side of a polarizer.

In the case where a plate having phase retardation, which is formed of a coating layer including an organic modified clay complex as described above or a compound polarizing plate where such a plate having phase retardation is layered on a polarizing plate, is pasted onto the cell glass of a liquid crystal display via an adhesive, the adhesiveness of the plate to the liquid crystal cell glass is sometimes lowered as time passes due to the plate having phase retardation.

The present inventors performed diligent research in order to solve the above described problem, and as a result, found that in the manufacture of a coating liquid for a plate with a coating having phase retardation by mixing an organic modified clay complex and a binder resin into an organic solvent, an additive that can adsorb an impurity that is included in the mixture is added for processing, and as a result, the adhesiveness of an adhesive can be prevented from lowering as time passes when a plate with a coating having phase retardation, which is manufactured from the above described coating liquid, is pasted onto the liquid crystal cell glass via the adhesive, and thus, the present invention has reached its completion.

### SUMMARY OF THE INVENTION

Accordingly, an object of the present invention is to manufacture a coating liquid for a plate with a coating having phase retardation which can maintain a high adhesiveness in the case where a plate with a coating having phase retardation, which includes an organic modified clay complex, is pasted onto the liquid crystal cell glass. Another object of the present invention is to manufacture a plate with a coating having phase retardation using such a coating liquid, and in addition, to manufacture a compound polarizing plate where such a plate with a coating having phase retardation is layered on a polarizing plate.

The present invention provides a method for manufacturing a coating liquid for a plate with a coating having phase retardation, wherein the method comprises a step of mixing an organic solvent, an organic modified clay complex and a binder resin, and a step of adding an adsorbent which can remove an impurity included in the mixture.

In this coating liquid, it is preferable for the weight ratio of an organic modified clay complex/binder resin to be more than 0.5 and to be not more than 4. It is preferable for the binder resin to be a urethane resin of which the base is an aliphatic diisocyanate, for example, a urethane resin of which the base is isophorone diisocyanate. It is preferable for the organic modified clay complex to be a complex of a quaternary ammonium compound having an alkyl group, of which the carbon number is 1 to 30, and a clay mineral that belongs to a smectite group.

Clay minerals that belong to a smectite group and anion exchange resins can be cited as examples of an adsorbent that is added to the coating liquid. After an adsorbent has been added to a solution where an organic modified clay complex and a binder resin are dispersed in an organic solvent for processing, it is preferable to filter the solution with a filter so as to remove solids of which the particles diameter is great.

In addition, the present invention provides a manufacturing method for a plate with a coating having phase retardation, wherein the method comprises a step of mixing an organic solvent, an organic modified clay complex and a binder resin, a step of adding an adsorbent which can remove an impurity included in the mixture, a step of applying the obtained coating liquid to a base, and a step of drying it.

Furthermore, the present invention provides a manufacturing method for a compound polarizing plate, wherein the method comprises a step of mixing an organic solvent, an organic modified clay complex and a binder resin, a step of adding an adsorbent which can remove an impurity included in the mixture, a step of applying the obtained coating liquid to a transfer base, a step of drying it to form a plate with a coating having phase retardation, a step of pasting a polarizing plate having an adhesive layer to an exposed surface of the plate with a coating having phase retardation on the adhesive layer side, and a step of removing the transfer base from said plate with a coating having phase retardation.

### BRIEF DESCRIPTION OF THE DRAWINGS

FIG. 1 is a schematic cross sectional diagram showing an example of the configuration of a compound polarizing plate where a plate with a coating having phase retardation is pasted to a polarizing plate;

FIG. 2 is a schematic cross sectional diagram schematically illustrating a manufacturing process for a compound polarizing plate;

FIG. 3 is a side diagram schematically showing a process for manufacturing a compound polarizing plate in roll form, up to the step of forming a plate with a coating having phase retardation and pasting a polarizing plate with an adhesive to the plate with a coating having phase retardation;

FIG. 4 is a side diagram schematically showing the step of providing a second adhesive layer to a compound polarizing plate;

FIG. 5 is a side diagram schematically showing the process for sequentially carrying out the steps from the formation of a plate with a coating having phase retardation to the formation of a second adhesive layer; and

FIG. 6 is a schematic cross sectional diagram showing an example of the configuration of a liquid crystal display.

### DETAILED DESCRIPTION OF THE PREFERRED EXAMPLES

In the following, the present invention is described in detail. First, a coating liquid for a plate with a coating having phase retardation is described. In this coating liquid for a plate with a coating having phase retardation, an organic modified clay complex and a binder resin are contained in an organic solvent. This coating liquid is manufactured in accordance with a method for dispersing or dissolving an organic modified clay complex and a binder resin in an organic solvent.

It is preferable for the organic modified clay complex and the binder resin to be mixed so that the weight ratio of the former/latter exceeds 0.5 and is no greater than 4. In the case where the weight ratio of the two in the mixture is out of this range, it tends to be difficult to maintain the haze value of the gained plate with a coating having phase retardation at a desired level. In particular, it is more preferable for the weight ratio of the two in the mixture to exceed 1 and be no greater than 3.

The concentration of the solid content in this coating liquid is not limited as long as the coating liquid after preparation is not converted to a gel or does not become cloudy so as to not cause problems for practical use, and usually a coating liquid, of which the concentration of the total solid content of an organic modified clay complex and a binder resin is in a range from approximately 3 wt % to 18 wt % is used. The optimal concentration of the solid content differs depending on the respective types of the organic modified clay complex and the binder resin and the composition ratio of the two, and therefore, is set for each compound, but generally it is more preferable for the concentration to be in a range from 6 wt % to 14 wt %. A variety of additives, such as a viscosity adjuster for improving applicability at the time when a film is formed on a base and a cross linking agent for further increasing hydrophobicity and/or durability, may be added to this coating liquid.

Though the organic solvent that is used for the coating liquid is not particularly limited, aliphatic hydrocarbons having low polarity such as benzene, toluene and xylene, and in addition, solvents having high polarity including ketones such as acetone, methyl ethyl ketone and methyl isobutyl ketone, lower alcohols such as methanol, ethanol and propanol, and hydrocarbon halides such as carbon tetrachloride, chloroform, dichloromethane and dichloroethane can be cited as examples. From among these, toluene, xylene, acetone, methyl isobutyl ketone and mixtures of these are preferable in that they allow an organic modified clay complex to disperse and a binder resin to be dissolved, and can prevent the coating liquid from converting to a gel.

Though the binder resin is not particularly limited as long as it is dissolved in any of the above described organic solvents, it is desirable for the binder resin to have hydrophobicity in order to gain appropriate resistance to heat and an easiness of handling. Polyvinyl acetal resins such as polyvinyl butyral and polyvinyl formal, cellulose based resins such as cellulose acetate butyrate, acryl based resins such as butyl acrylate, methacrylate based resins, urethane resins, epoxy resins, polyester resins and the like can be cited as examples of a preferable binder resin. From among these, urethane resins, of which the base is aliphatic diisocyanate, can be cited as preferable examples.

Urethane resins, of which the base is aliphatic diisocyanate, are generated by causing an additional reaction between an aliphatic compound having a number of isocyanate groups within a molecule and a compound having a number of active hydrogens such as a hydroxyl group within a molecule. Hexamethylene diisocyanate, dicyclohexylmethane diisocyanate, cyclohexane diisocyanate, hydrogenated xylylene diisocyanate, isophorone diisocyanate, norbornene diisocyanate and the like can be cited as an aliphatic compound having a number of isocyanate groups within a molecule. From among these, in particular, those of which the base is isophorone diisocyanate are preferable.

In addition, polyether polyol, polyester polyol, polycarbonate polyol, polycaprolactone polyol and the like can be cited as a compound having a number of hydroxyl groups within a molecule. From among these, polyether polyol and polyester polyol are preferably used, but the compound is not limited to these, and a mixture of these may also be used.

Polyether polyol is manufactured through the ring opening polymerization or copolymerization of a cyclic ether such as, for example, ethylene oxide, propylene oxide, trimethylene oxide, butylene oxide, a-methyl trimethylene oxide, 3,3-dimethyl trimethylene oxide, tetrahydrofuran and dioxane, and is also referred to as polyether glycol or polyoxy alkylene glycol.

Polyester polyol is manufactured through the condensation polymerization of a polybasic organic acid, particularly dicarboxylic acids, and polyol. Saturated aliphatic acids such as oxalic acid, succinic acid, glutaric acid, adipic acid, pimelic acid, suberic acid, azelaic acid, sebacic acid and isosebacic acid, unsaturated aliphatic acids such as maleic acid and fumaric acid as well as aromatic carboxylic acids such as phthalic acid and isophthalic acid can be cited as examples of a dicarboxylic acid. Diols such as ethylene glycol, diethylene glycol, triethylene glycol, propylene glycol and butylene glycol, triols such as trimethylolpropane, trimethylolethane, hexanetriol and glycerine, and hexaols such as sorbitol can be cited as examples of polyols, but the polyol is not limited to these, and two or more types may be mixed for use.

It is preferable for the binder resin to have a glass transition temperature of no higher than 20° C., and it is more preferable for the glass transition temperature to be no higher than −20° C. In the case where the glass transition temperature of the binder resin is high, the rubber elasticity becomes insufficient, and the adhesiveness and flexibility of the plate having phase retardation and of a compound polarizing plate where such a plate having phase retardation is layered on a polarizing plate tend to become inferior.

The organic modified clay complex is a complex of an organic compound and a clay mineral, and concretely speaking, a complex of a clay mineral having a layer structure and an organic compound. A smectite group and swelling micas can be cited as a clay mineral having a layer structure, and it becomes possible for them to compound with an organic compound due to its cation exchange ability. From among these, a smectite group is superior in transparency, and therefore, is preferably used. Hectorite, montmorillonite, bentonite and substitutes, derivatives and mixtures of these can be cited as examples which belong to the smectite group. From among these, those which are chemically synthesized are preferable in that they have a small amount of impurities and are superior in transparency. In particular, synthetic hectorite, of which the grain diameter is small as a result of control, is preferably used because the scattering of visible light beams can be suppressed.

Compounds which can react with oxygen atoms or hydroxyl groups in a clay mineral and ionic compounds which are exchangeable with exchangeable cations can be cited as an organic compound that is compounded with a clay mineral, and the organic compound is not particularly limited as long as it allows an organic modified clay complex to be swollen or dispersed in an organic solvent, but concretely speaking, a nitrogen containing compound can be cited as an example. Primary, secondary and tertiary amines, quaternary ammonium compounds, urea, hydrazine and the like can be cited as the nitrogen containing compound. From among these, quaternary ammonium compounds are preferably used because cation exchange is easy.

Compounds having a long chain alkyl group and compounds having an alkyl ether chain can be cited as examples of the quaternary ammonium compounds. From among these, quaternary ammonium compounds having an alkyl group of which the carbon number is 1 to 30, a —(CH₂CH(CH₃)O)ₙH group, where n=1 to 50, or a —(CH₂CH₂ CH₂O)ₙH group are preferable. Compounds having an alkyl group, of which the carbon number is 6 to 10, are more preferable.

In the case where an organic modified clay complex is formed of an organic compound and a clay mineral that belongs to a smectite group, this clay mineral that belongs to the smectite group is not particularly limited as long as it can be swollen or dispersed in an organic solvent in a state where the clay mineral forms a complex with the organic compound, but in the case of the clay material where it is difficult for the exchangeable cations to be exchanged with an ionic organic compound, it is difficult for the clay mineral to be dispersed in an organic solvent. In many cases, a magnesium compound such as magnesium hydroxide adheres to the surface of a synthetic product of a clay mineral which belongs to a smectite group, and in the case where this amount of magnesium compound is great, the exchangeable cation site is blocked. Therefore, the products, in the case where the magnesium compound on the surface is removed through washing with acid so that the ratio of the existing magnesium is lowered, concretely speaking, the atomic ratio of magnesium to four atoms of silicon (Mg/Si₄) is less than 2.73, easily disperse in an organic solvent, and therefore, are preferable. Hectorite, which belongs to a smectite group, is typically represented by a composition formula of Na_{0.66}(Mg_{5.34}Li_{0.66})Si₈O₂₀(OH)₄.nH₂O or Na_{1/3}(Mg_{8/3}Li_{1/3})Si₄O₁₀(OH)₂.mH₂O, as shown in the “Unabridged Dictionary of Chemistry”, edited by the Unabridged Dictionary of Chemistry editing committee (Kyoritsu Shuppan Co., Ltd., first edition issued on Feb. 28, 1962), and the atomic ratio of Mg/Si₄ in this state is 2.67 while the atomic ratio of Mg/Si₄ of synthetic hectorite is slightly greater than 2.67 due to the magnesium compound which exists on the surface as described above. The products where the magnesium compound which exists on the surface as described above is removed through washing with acid or the like so that the atomic ratio of Mg/Si₄ is made to be as close to 2.67 as possible are preferably used. Sodium becomes exchangeable cations in hectorite or in a clay mineral of a smectite group, including synthetic hectorite, and these cations are exchanged with an organic compound, for example, a quaternary ammonium group, so that an organic modified clay complex is gained, and therefore, the atomic ratio of Mg/Si₄ does not change before and after the modification

Two or more types of organic modified clay complexs may be combined for use. Commercially available products of appropriate organic modified clay complexs include a complex of a synthetic hectorite which is sold by CO-OP chemical Co., Ltd. under a trade name “Lucentite STN” or “Lucentite SPN” and a quaternary ammonium compound.

An organic solvent, an organic modified clay complex and a binder resin as described above are mixed so that a coating liquid for a plate with a coating having phase retardation is provided and in the case where this coating liquid is applied to a flat base as is, and then dried so that a plate with a coating having phase retardation is provided, the adhesiveness of an adhesive to the liquid crystal cell glass is sometimes lowered as time passes when this plate is pasted to the liquid crystal cell glass via the adhesive. It has been found that the adhesiveness is lowered in this manner under the influence of the existence of an impurity which seems to be mainly originated from a variety of sub-materials which are used at the time of the manufacture of the organic modified clay complex.

Therefore, according to the present invention, an adsorbent which can remove an impurity that is included in the above described coating liquid is further added for processing, and thus, the impurity is removed. Though the adsorbent used here is not particularly limited as long as it has an ability to remove an impurity which exists in the mixture of an organic solvent, and organic modified clay complex, and a binder resin, a compound which can adsorb or ion exchange released components which are included in the organic modified clay complex is desirable and clay minerals which belong to a smectite group and are not modified with an organic substance or anion exchange resins are preferable as examples which are concretely cited.

The amount of the added adsorbent varies depending on the amount of impurities which exists in the coating liquid and the adsorbing ability or ion exchanging ability of the adsorbent and is generally selected from a range from approximately 3 weight parts to 300 weight parts for 100 weight parts of the organic modified clay complex in the coating liquid. Adsorbent is added to the mixture of an organic solvent, an organic modified clay complex and a binder resin, and this liquid mixture in this state is stirred so as to be processed by the adsorbent. The adsorbent maybe added as an arbitrary stage during the process for preparing the coating liquid such as when the binder resin and organic modified clay complex are dispersed in the organic solvent or after the dispersion and filtering for refinement.

In the case where solids having a large particle diameter exist in the gained coating liquid, a portion which does not transmit light is generated, or polarization dissolving function is created due to light scattering in a plate with a coating having phase retardation which is fabricated from the coating liquid, and this causes the optical performance of a liquid crystal display which uses this plate to be lowered. In addition, the organic modified clay complex is peptized through stirring of the coating liquid so that the particle diameter becomes smaller and in the case where some organic modified clay complex which has not sufficiently been peptized in such a manner particles having a large diameter, for example, particles of which the diameter is no less than 1 μm exists, this still causes the optical performance of the plate with a coating having phase retardation to be lowered. Therefore, it is desirable for this coating liquid to be filtered with a filter so that such solids that may exist are removed. Here, in this filtering process, the organic modified clay complex that has been peptized in the coating liquid must not be removed. The filter should remove most of the solids of which the particle diameter is not less than 1 μm, and therefore, it is preferable to select a filter which can remove most of the solids of which the particle diameter is no less than 1 μm for use from among filters of which the pore diameter is approximately 0.5 μm to 10 μm, taking into consideration a change in the particle diameter that can be filtered due to clogging of the filter. Here, the particle diameter of the peptized organic modified clay complex is approximately 10 nm to 200 nm. In the case where a clay mineral which belongs to a smectite group is used as an adsorbent, the clay mineral forms a plate with a coating having phase retardation in a state where this is mixed with an organic decorating clay compound, and thus, a clay mineral of which the particle diameter has become no greater than 1 μm through peptization can be used as is for the manufacture of a plate with a coating having phase retardation without causing any particular problems, while in the case where an anion exchange resin is used as an adsorbent, it is necessary to remove this after processing.

Next, an manufacturing method for a plate having phase retardation is described. A coating liquid which contains an organic modified clay complex, a binder resin, and an organic solvent as described above, and from which impurities have been removed through processing using an adsorbent is applied to a flat base, and is dried so that the organic solvent is removed, and thereby, a plate with a coating having phase retardation can be gained. In this manner, a composition that is gained by removing the organic solvent from the above described coating liquid is formed in a film form, which becomes a plate with a coating having phase retardation. This plate having phase retardation is provided in a single film form made of the above described composition, or in a film form where this composition is coated on a support base.

The layer structure of the unit crystal layer of the organic modified clay complex is parallel to the surface of the flat base and oriented at random within the plane as a result of the above described application and drying. Accordingly, a structure where the index of refraction within the film surface is greater than the index refraction of the film in the direction of the thickness can be gained without requiring a specific orientation process.

Though the base for applying a coating liquid is not particularly limited, a polyethylene terephthalate film on which a mold release process has been carried out can be cited as an example. In addition, though the temperature and the period of time for drying the coated film are not particularly limited as long as they are sufficient for removing the used organic solvent, an appropriate temperature may be selected, for example, from a range from approximately 50° C. to 150° C. and an appropriate period of time may be selected from a range from approximately 30 seconds to 30 minutes.

It is preferable for the phase retardation value R₀ within a plane of the plate having phase retardation that has been gained in the above described manner to be in a range from 0 nm to 10 nm, and it is preferable for the phase retardation value R′ in the direction of the thickness to be in a range from 40 nm to 350 nm. Here, in the case where phase retardation value R₀ within a plane exceeds 10 nm, this value can not be ignored and a negative uniaxiality in the direction of the thickness is damaged. In addition, an appropriate phase retardation value R′ in the direction of the thickness is selected in accordance with the application of this plate having phase retardation, in particular, the properties of the liquid crystal cell where a compound polarizing plate is pasted for use, and it is preferable for the thickness to be approximately 50 nm to 300 nm. The phase retardation value R′ in the direction of this thickness can be controlled by the thickness of the above described coating liquid when this is applied. Accordingly, the thickness of the film for forming a dried plate having phase retardation is not particularly limited and may be a thickness that is required to realize phase retardation necessary for the plate having phase retardation.

Anisotropy of the index of refraction in the direction of the thickness is represented by the phase retardation value R′ in the direction of the thickness that is defined in the above described formula (II), and this value can be calculated from the phase retardation value R₄₀ that has been measured by inclining the late phase axis within the plane by 40 degrees, creating an inclined axis and the phase retardation R₀ within the plane. Concretely speaking, nₓ, n_{y} and n_{z} are found through numerical calculations from the following formulas (III) to (V) using the phase retardation value R₀ within the plane, the phase retardation value R₄₀ that has been measured by inclining the late phase axis by 40 degrees creating an inclined axis, the thickness d of the film and the average index of refraction n₀ of the film, and the values of nₓ, n_{y} and n_{z} are substituted in the above described formula (II) so that R′ can be calculated.
R₀=(nₓ−n_{y})×d (III)
R₄₀=(nₓ−n_{y}′)×d/cos(f) (IV)
(nₓ+n_{y}+n_{z})/3=n₀ (V)
where
f=sin⁻¹[sin(40°)/n₀]
n_{y}′=n_{y}×n_{z}/[n_{y}²×sin²(f)+n_{z}²×cos²(f)]^{1/2}

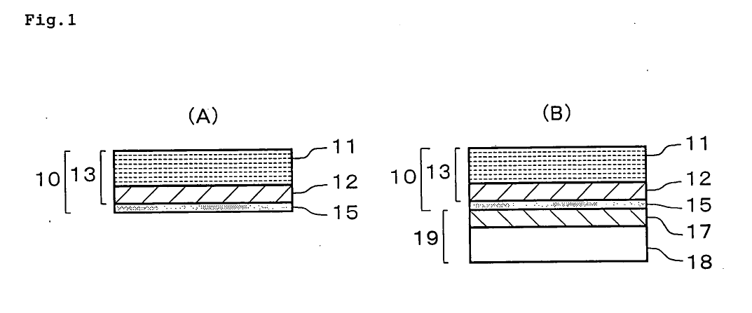

Next, a manufacturing method for a compound polarizing plate is described. In a compound polarizing plate, which is an object here, as shown in FIG. 1(A), a polarizing plate 11, an adhesive layer 12, and a plate having phase retardation 15 as that described above are layered in this order. Polarizing plate 11 and adhesive layer 12 are usually prepared in the form of a polarizing plate 13 with an adhesive. Plate having phase retardation 15 is formed of a coating layer having anisotropy of this index of refraction as that described above and this coating layer may be formed of one layer or may be formed of multiple, two or more, layers.

This compound polarizing plate 10 is usually pasted to the liquid crystal cell for use in such a manner that plate having phase retardation 15 thereof is placed on the liquid crystal cell side, in other words, in a state where polarizing plate 11 is located on the outside. Therefore, a second adhesive layer 17 may be provided on the outside of plate having phase retardation 15 as shown in FIG. 1(B) in order to be pasted to the liquid crystal cell. In this case, a mold release film 18 is provided outside of second adhesive layer 17 and this mold release 18 is removed before pasting so that the surface of second adhesive layer 17 can be pasted to the liquid crystal cell. A film 19 with an adhesive where an adhesive layer 17 is provided on a mold release film 18 is prepared and this film can be layered on plate with a coating having phase retardation 15 on the adhesive layer 17 side.

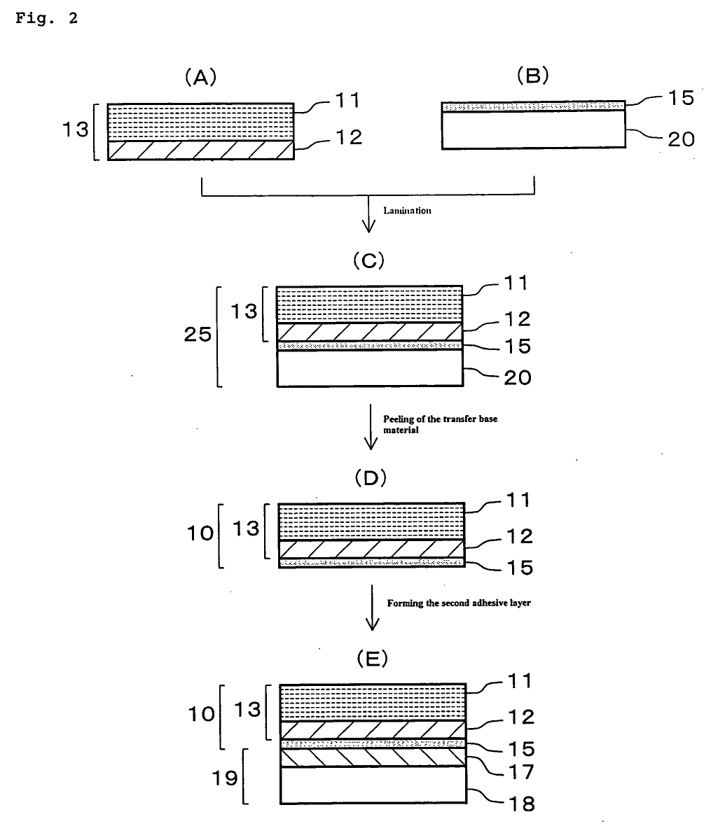

In order to form such a compound polarizing plate, a method where plate with a coating having phase retardation 15 is formed on a transfer base, and after that, the plate is transferred to the surface of adhesive layer 12 of polarizing plate 13 with an adhesive may be adopted. This method is described on the basis of FIG. 2.

First, as shown in FIG. 2(A), a polarizing plate 13 with an adhesive where an adhesive layer 12 is formed on the surface of a polarizing plate 11 is prepared. Separately, as shown in FIG. 2(B), a plate with a coating having phase retardation 15 is formed on the surface of a transfer base 20 in accordance with the method described above. Next, polarizing plate 13 with an adhesive shown in FIG. 2(A) and transfer base 20 shown in FIG. 2(B) are pasted together in such a manner that adhesive layer 12 of polarizing plate 13 with an adhesive and plate with a coating having phase retardation 15 on transfer base 20 make contact with each other, and thus, a half finished product 25 in such a state that the structure is: polarizing plate 11/adhesvive layer 12/plate with a coating having phase retardation 15/transfer base 20 shown in FIG. 2(C) is gained. After that, when the transfer base 20 is removed, as shown in FIG. 2(D), compound polarizing plate 10 in the state shown in FIG. 1(A) is gained. Furthermore, as shown in FIG. 2(E), when a second adhesive layer 17 and a mold release film 18 are provided on the surface of plate with a coating having phase retardation 15 after the transfer base is removed, a compound polarizing plate 10 with an adhesive layer 17 in the state shown in FIG. 1(B) is gained. The second adhesive layer 17 may be provided by applying an adhesive directly to plate with a coating having phase retardation 15, or may be provided by preparing a film 19 with an adhesive gained by applying an adhesive to mold release film 18 in advance, and then drying this, and pasting the adhesive layer 17 side of the film to plate with a coating having phase retardation 15.

In addition, a corona process may be carried out on the surface of either adhesive layer 12 or plate with a coating having phase retardation 15, or either plate with a coating having phase retardation 15 or second adhesive layer 17 in order to enhance the adhesiveness between the two.

The type of polarizing plate 11 used as the compound polarizing plate is not particularly limited, as long as it has the ability to selectively transmit linear polarized light in the direction of a specific vibration. Concretely, there is a type where a resin film such as a polyvinyl alcohol based resin is used as a base and a dichromatic pigment is adsorbed and oriented in the base. Typically, iodine or a dichromatic organic dye is used as the dichromatic pigment. Plates of uniaxially stretched polyvinyl alcohol in which iodine molecules are adsorbed and oriented, plates of uniaxially stretched polyvinyl alcohol in which an azo based dichromatic dye is adsorbed and oriented and the like can be cited as examples of the polarizing plate. A polyvinyl alcohol based polarizer in which a dichromatic pigment as that described above is adsorbed and oriented has a function of absorbing linear polarized light having the vibration surface in the direction of orientation of the dichromatic pigment and transmitting linear polarized light having the vibration surface in the direction perpendicular to this direction.

These polarizing plates are generally used in a form where a protective layer made of a polymer film such as a triacetyl cellulose film is formed on one or two sides of a polarizer made of a polyvinyl alcohol based film. In the case where a protective layer is provided only on one side of the polarizer, this protective layer is placed on the outside when this protective layer is pasted to the liquid crystal cell, and the surface having no protective layer is placed on the adhesive layer 12 side.

Adhesives where an acrylic based polymer, a silicone based polymer, polyester, polyurethane, polyether and the like are used as the base polymer can be cited as the adhesive used for the formation of the compound polarizing plate. From among these, it is preferable to select for use an adhesive such as an acryl based adhesive which is highly optically transparent, maintains appropriate wettability and coagulation, has high adhesiveness to the base, as well as weather and heat resistance, and does not cause any problems such as lifting or peeling under conditions where heat and humidity are applied. An acryl based copolymer of which the weight average molecular weight is no lower than 100,000 and where an alkyl (meth)acrylate having an alkyl group, for example, a methyl group, an ethyl group or a butyl group, of which the carbon number is. no greater than 20, and an acryl based monomer containing a functional group made of (meth)acrylic acid, hydroxyethyl (meth)acrylate or the like are mixed with a glass transition temperature of preferably no higher than 25° C. and more preferably no higher than 0° C. and polymerized is effective as the base polymer for an acryl based adhesive. The thickness of each of adhesive layers 12 and 17 is usually approximately 15 μm to 30 μm.

Here, as described above in reference to FIGS. 2(A) to 2(E), according to the present invention, a method where plate with a coating having phase retardation 15 having anisotropy in the index of refraction is formed in advance on transfer base 20, and after that, this is transferred to adhesive layer 12 on polarizing plate 11 is preferably adopted. By adopting such a method, it becomes unnecessary to carry out a process for drying the coating layer on the polarizing plate, and therefore, a compound polarizing plate can be effectively manufactured without heat causing deterioration in the polarizer and without causing deficiency in the coating layer due to insufficient drying.

Transfer base 20 is a film which is processed so that a layer that is formed on the surface can be easily removed, and in general, is a commercially available film where a mold release processing has been carried out by applying a mold release agent such as a silicone resin or a fluorine resin to the surface of a resin film such as polyethylene terephthalate. In addition, plate with a coating having phase retardation 15 is formed on transfer base 20, and therefore, it is preferable for the angle at which transfer base 20 makes contact with water to be in a range from 90° to 130°, and it is more preferable for the angle of contact with water to be no smaller than 100° and no greater than 120°. In the case where the angle at which transfer base 20 makes contact with water is less than 90°, the peeling properties of transfer base 20 are poor, and defects such as irregular phase retardation easily occur in plate with a coating having phase retardation 15. In addition, in the case where the angle of contact with water is greater than 130°, the coating liquid is easily repelled by transfer base 20 before being dried, and in some cases, irregularities in dot form may occur in the phase retardation within a plane. Here, angle of contact with water means the angle of contact with a liquid when water is used as the liquid, and the greater the value is, the more difficult it is for the material to become wet with water. Here, the upper limit of the angle of contact with water is 180°.

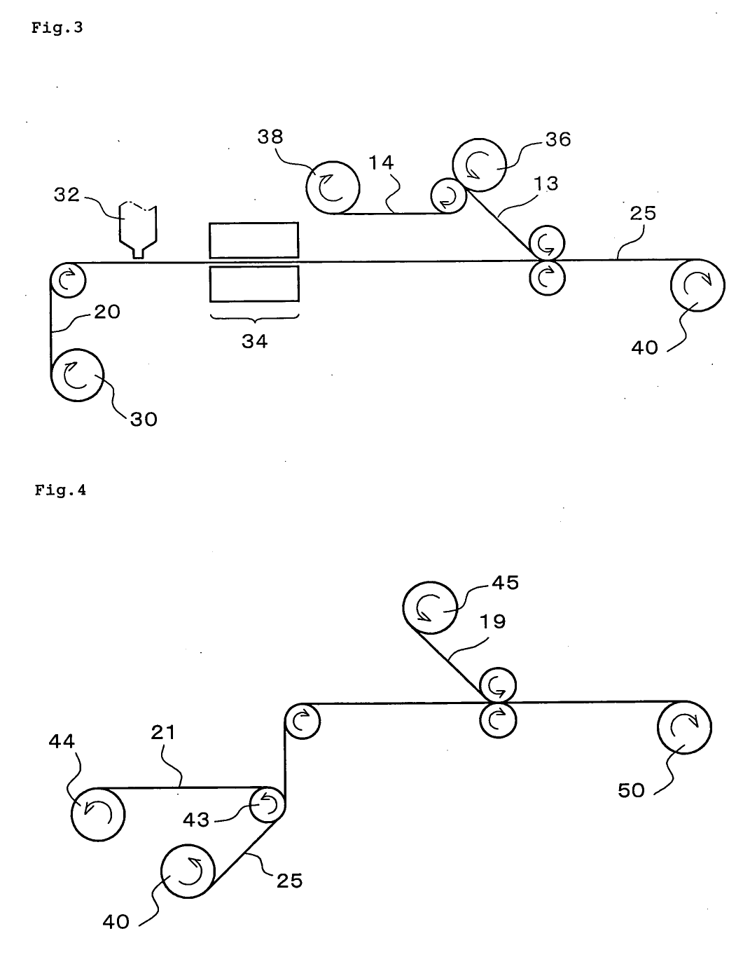

In reference to FIGS. 2(A)to 2(E), particularly FIG. 2(E), second adhesive layer 17 can be provided on the outside of plate with a coating having phase retardation 15 as described above. In the case where second adhesive layer 17 is provided in this manner, it is effective to carry out the first process where plate with a coating having phase retardation 15 is formed on transfer base 20, and after that, an exposed surface of this plate with a coating having phase retardation 15 is layered on adhesive layer 12 of polarizing plate 11, and the second process of where second adhesive layer 17 is formed on the surface of plate with a coating having phase retardation 15 from which the transfer base has been removed while removing transfer base 20 from this plate with a coating having phase retardation 15, which is layered on a polarizing plate, in this order. The outline of the above described first process and the outline of the second process in the case where a compound polarizing plate is produced in roll form are illustrated in the side diagram of FIG. 3 and in the side diagram of FIG. 4, respectively.

In the first process, a plate with a coating having phase retardation and anisotropy in the index of refraction is formed on a transfer base, and an adhesive surface of the polarizing plate is pasted to the surface of this plate with a coating having phase retardation that is exposed to air, and this is rolled up. This is described in further detail in reference to FIG. 3. A coating liquid for a plate with a coating having phase retardation is applied to the surface of transfer base 20 that has been fed out from a roll 30 for feeding out a transfer base using a coater 32, and subsequently, the transfer base is passed through a drying zone 34 so as to be dried, and after that, pasted to a polarizing plate 13 with an adhesive. Polarizing plate 13 with an adhesive is usually supplied in a form where a removable mold release film is pasted to the surface of the adhesive layer of the polarizing plate, and therefore, first, mold release film 14 is removed from polarizing plate 13 with an adhesive that has been fed out from roll 36 for feeding out a polarizing plate, and is then rolled up around roll 38 for rolling a mold release film. In addition, the surface of polarizing plate 13 with an adhesive from which an adhesive layer is exposed is pasted to the surface of the plate with a coating having phase retardation that has been formed on the above described transfer base, and a half finished product 25 having a layer configuration made up of polarizing plate/adhesive layer/plate with a coating having phase retardation/transfer base is gained, and this is rolled up around a roll 40 for a half finished product.

As compared to a conventional method where a protective film is pasted to the surface of a plate with a coating having phase retardation that is exposed to air and this is rolled up, this is additionally fed out, and then, the plate with a coating having phase retardation is pasted to a polarizing plate while removing the protective film, this first process has a smaller number of steps and is advantageous in terms of cost, and in addition, it is difficult for a defect originating from failure at the time of removal of the protective film or a defect caused by a foreign substance originating from the protective film to be caused, and therefore, a half finished product 25 having extremely good quality can be gained. In addition, when this half finished product is rolled up, it is also technically effective to use a side tape and roll up the half finished product, so that the surfaces thereof do not make contact with each other, in order to prevent the mold releasing agent of transfer base 20 from shifting to the plate with a coating having phase retardation due to the pressure when being rolled up.

The coating system that is used for the formation of the plate with a coating having phase retardation in the first process is not particularly limited, and a variety of well known coating methods, such as a direct gravure method, a reverse gravure method, a dye coating method, a comma coating method and a bar coating method, can be used. From among these, a comma coating method, a dye coating method which does not use a backup roll and the like are preferably adopted, because they allow for excellent precision in the thickness.

In the subsequent second process, an adhesive layer is formed on the surface of the plate with a coating having phase retardation after the removal of the transfer base while removing the transfer base from the half finished product gained in the first process, that is to say, an adhesion process is carried out. This is described in further detail in reference to FIG. 4. Half finished product 25 that is once rolled up around roll 40 for a half finished product in the first process shown in FIG. 3 is fed out from the same roll 40 and the transfer base 21 is removed by roll 43 for removing the transfer base, and after that, film 19 with an adhesive that is supplied from feed out roll 45 to the surface of the plate with a coating having phase retardation that is exposed through removal of the transfer base so that the two are pasted together in such a manner that the adhesive layer side of the film is pasted to the surface of the plate, and this is rolled up around a roll 50 for a product. The transfer base 21 removed from the half finished product 25 is to be rolled up around a roll 44 for rolling the transfer base. Here, though a form where film 19 with an adhesive is used for the formation of the second adhesive layer is shown, the adhesive may be applied directly to the plate with a coating having phase retardation, as described above. Through these processes, a compound polarizing plate having a polarizing plate/adhesive layer/plate with a coating having phase retardation/adhesive layer arranged in this order is gained.

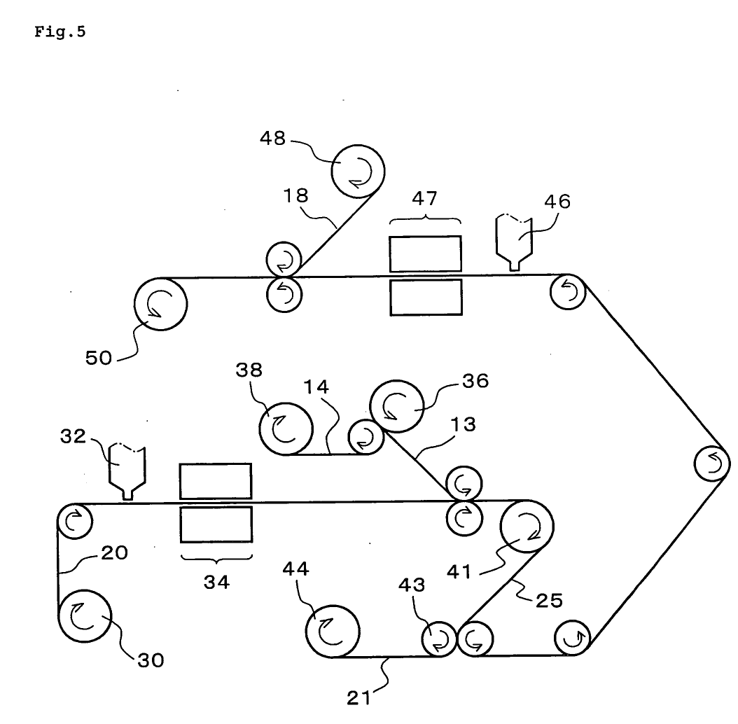

The first process, shown in FIG. 3, and the second process, shown in FIG. 4, may make up a sequence. An example of such a case is shown in a schematic side diagram in FIG. 5. In FIG. 5, the same symbols are attached to portions of FIGS. 3 and 4 which are the same, and detailed descriptions of these are omitted. In this example, a coating liquid for a plate with a coating having phase retardation is applied to the surface of transfer base 20 that is fed out from roll 30 for feeding out a transfer base using coater 32, and this is subsequently passed through drying zone 34 so as to be dried, and after that, the adhesive layer side of polarizing plate 13 with an adhesive after being fed out from roll 36 for feeding out a polarizing plate and after mold release film 14 has been removed is pasted to the side of the plate with a coating having phase retardation, and thus, half finished product 25 having a layer structure made up of polarizing plate/adhesive layer/plate with a coating having phase retardation/transfer base is gained, and the process up to this point is the same as the first process shown in FIG. 3.

After that, half finished product 25 is passed through a roll 41 for rolling a half finished product without being rolled up around a roll, and then, the transfer base is removed by roll 43 for removing a transfer base, and thus, transfer base 21 after removal is rolled up around a roll 44 for rolling. Meanwhile, an adhesive is applied to the surface of the plate with a coating having phase retardation after the removal of transfer base 21 using an adhesive coater 46, and this is passed through an adhesive drying zone 47 so as to be dried, and after that, a mold release film 18 that is fed out from a roll 48 for a mold release film is pasted to the coating surface of the plate and wound up around roll 50 for a product. Though in this example a direct coating an drying system where an adhesive coater 46 and a drying zone 47 are used for the formation of a second adhesive layer is shown, a system where a film with an adhesive is used may be adopted, as shown in FIG. 4.

In the case where plate with a coating having phase retardation 15 is left in such a state as to be making contact with transfer base 20 for a long period of time, the mold releasing agent on transfer base 20 sometimes moves toward plate with a coating having phase retardation 15, so that the angle at which the surface of plate with a coating having phase retardation 15 makes contact with water increases after the removal of transfer base 20 (21 after removal). In consideration of the adhesiveness between the surface of the plate with a coating having phase retardation 15 after the removal of transfer base 21 and second adhesive layer 17, it is preferable to remove the transfer base and carry out an adhesive process in the second process under conditions where the angle at which the surface of the plate with a coating having phase retardation 15 makes contact with water after the removal of the transfer base is greater by 15° or less, preferably by 10° or less, than the angle at which plate with a coating having phase retardation 15 makes contact with the surface that is exposed to air when plate with a coating having phase retardation 15 is formed on transfer base 20 [see FIG. 2(B)]. In order to do so, it is preferable to move to the second process as soon as possible after the completion of the first process. In addition, it is also technically effective to carry out a corona process on the surface of either plate with coating having phase retardation 15 or second adhesive layer 17 when an adhesion process is carried out on plate with a coating having phase retardation 15 after the removal of transfer base 21.

Here, the rounded arrows in FIGS. 3 to 5 represent the direction in which the rolls rotate.

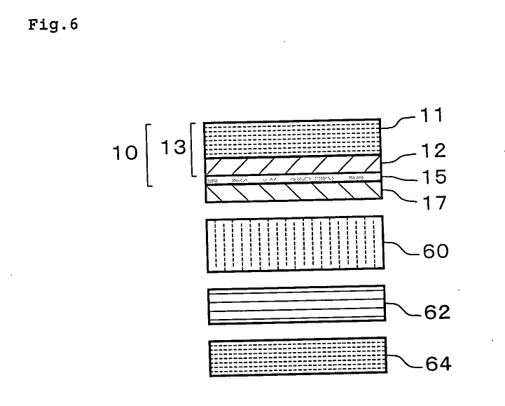

Next, the liquid crystal display is described. A liquid crystal display where a plate having phase retardation or a compound polarizing plate manufactured according to the present invention is arranged has a configuration of which an example is shown in the cross sectional diagram of FIG. 6, where a compound polarizing plate 10 as that described above is placed on one surface of a liquid crystal cell 60, generally with a second adhesive layer 17 in between, in such a manner that the phase retardation plate 15 side of the compound polarizing plate makes contact with the second adhesive layer, and a second plate having phase retardation 62 and a second polarizing plate 64 are placed in this order on the other side of liquid crystal cell 60.

Second plate having phase retardation 62 which is placed between liquid crystal cell 60 and second polarizing plate 64 has a phase retardation value R₀ within a plane of 30 nm to 300 nm, and it is preferable for the configuration to have a ratio R₀/R′ of phase retardation ratio R₀ within a plane to phase retardation value R′ in the direction of the thickness exceeding 0 and of less than 2, that is to say, 0<R₀/R′<2. A plate having phase retardation having such phase retardation properties is combined with a compound polarizing plate manufactured according to the present invention as described above, and thereby, the view angle characteristics of the crystal display can be improved. A plate having phase retardation which provides such phase retardation properties can be manufactured in accordance with a method for uniaxially stretching a polymer film from a roll, for example, with one end fixed using a tenter, concretely, for stretching a film laterally and uniaxially with one end fixed. It is preferable for R₀/R′ to be in a range from 0.8 to 1.4, because this allows second plate having phase retardation 62 to be easily fabricated in accordance with uniaxial stretching with one end fixed and have excellent optical properties when applied to a liquid crystal display.

The material for second plate having phase retardation 62 is not particularly limited, and polycarbonate, polyurethane, cyclic olefin based resins of which the monomer is a polycyclic olefin, such as norbornene, cellulose groups, polyolefin groups and copolymers where two or more types of monomers which form any of these polymer compounds are used can be cited as examples of the material. Cyclic olefin based resins having a small photoelastic coefficient are preferable, taking the stability of optical properties under the thermal conditions of high temperature and high humidity or in a tense state into consideration. In addition, though the dependency on wavelength of the phase retardation value is not particularly limited in this second plate having phase retardation 62, it is preferable for the plate to have such a phase retardation distribution that the shorter the wavelength is, the smaller the phase retardation value is, taking into consideration control over color, in terms of appearance.

Second polarizing plate 64 may be a polyvinyl based polarizer in which a dichromatic pigment is adsorbed and oriented where a protective layer made of a polymer film is formed on one or two sides, in the same manner as with polarizing plate 11 described above in reference to FIG. 1.

It is preferable for a protective layer to exist and be placed on at least the exposed surface (lower side in FIG. 6) of second polarizing plate 64. In addition, second plate having phase retardation 62 may be made to make direct contact with the polarizer of second polarizing plate 64 using an adhesive or glue instead of a protective layer on one side of second polarizing plate 64. In this case, second polarizing plate 64 has a protective layer only on one side of the linear polarizer, and second plate having phase retardation 62 is layered on the side of the polarizer which does not have a protective layer.

Second polarizing plate 64 and second plate having phase retardation 62 maybe installed in such a manner that the absorbing axis of the former and the delay phase axis of the latter cross at an angle between 80° and 100°, and it is preferable for the angle between the two axes to be between 85° and 95°, taking increase in the contrast ratio and reduction in the unevenness of the color into consideration. More preferably, the two plates are installed in such a manner that the angle between the axes is between 89° and 91°.

Here, though not shown in the figure, an adhesive, for example one having an acryl base, can be used to paste liquid crystal cell 60 and second plate having phase retardation 62 together. In addition, an adhesive, for example one having an acryl base, can be used to paste second plate having phase retardation 62 and second polarizing plate 64 together, particularly in the case where second polarizing plate 64 has a protective layer on the two sides. The same can be said for acryl based adhesives.

In the case where a transmission type display is used as the liquid crystal display shown in FIG. 6, a backlight is placed either on the outside of compound polarizing plate 10 of the display or the outside of second polarizing plate 64. The backlight may be placed on either side. Accordingly, in the first mode of the liquid crystal display, compound polarizing plate 10 according to the present invention is placed on the front side (side from which the display is viewed) of liquid crystal cell 60, and second plate having phase retardation 62 and second polarizing plate 64 are placed on the rear side (backlight side in case of transmission type). In addition, in the second mode of the liquid crystal display, compound polarizing plate 10 is placed on the rear side of liquid crystal cell 60, and second plate having phase retardation 62 and second polarizing plate 64 are arranged on the front side. The axis angle and the like of each layer is set so that the viewing angle properties become optimal in the arrangement of the second plate having phase retardation and the second polarizing plate.

It is desirable for second adhesive layer 17 that is placed to paste liquid crystal cell 60 and plate with a coating having phase retardation 15 together to have an adhesiveness to liquid crystal cell glass that does not deteriorate with the passing of time. The adhesiveness is a force that is created through contact between the adhesive surface of the adhesive sheet and the surface of the object to which it is to adhere, and a method for testing this is prescribed in JIS Z 0237. In some plates having phase retardation which are fabricated from a coating liquid in a state where a conventional organic solvent, an organic modified clay complex and a binder resin are mixed, adhesiveness becomes much lower as time passes in comparison with immediately after the plate having phase retardation is pasted to liquid crystal cell glass via an adhesive. A coating liquid from which an impurity has been removed by processing the coating liquid after an adsorbent has been added is used so as to fabricate a plate with a coating having phase retardation as that described above, and thereby, reduction of the above described adhesiveness as time passes can be lessened. Concretely, no less than 50%, and furthermore, no less than 80% of the adhesiveness can be maintained after one week of storage at 23° C. in a state where the plate with a coating having phase retardation is pasted to liquid crystal cell glass via an adhesive or in a state where a compound polarizing plate where a plate with a coating having phase retardation is layered on a polarizing plate is pasted to liquid crystal cell glass via an adhesive in such a manner that the side of this plate with a coating having phase retardation makes contact with the adhesive, relative to the adhesiveness immediately after pasting.

### EXAMPLES

Though in the following, the present invention is described in further detail on the basis of the examples, the present invention is not limited to these examples. In the examples, % and parts, which represent content and amount of use, are based on the weight unless otherwise specified. The materials used for the preparation of a coating liquid in the following examples are as follows.

(A) Organic Modified Clay Complex

trade name “Lucentite STN”: complex of synthetic hectorite and trioctyl methyl ammonium ions, sold by CO-OP Chemical Co., Ltd.

(B) Binder Resin

trade name “SBU Lacquer 0866”: isophorone diisocyanate based urethane resin varnish, sold by Sumika Bayer Urethane Co., Ltd., solid concentration: 30%

(C) Adsorbent

trade name “Lucentite SWN”: synthetic hectorite (clay mineral, not modified with organic substance), sold by CO-OP Chemical, Co., Ltd.

trade name “Duolite A161TRS04”: anion exchange resin, sold by Sumika Chemtex Co., Ltd.

In addition, measurement and evaluation of the property values of samples were carried out in accordance with the following method.

(1) Phase Retardation Value R₀ Within Plane

A plate with a coating having phase retardation that is formed on a transfer base is transferred to a square glass plate of 4 cm using an adhesive. Phase retardation value R₀ within a plane is measured on a plate having phase retardation in a state where the plate having phase retardation is pasted to a glass plate in this manner in accordance with a rotating-analyzer method with light of a single color having a wavelength of 559 nm using a measuring machine “KOBRA-21ADH,” made by Oji Scientific Instruments Co., Ltd. Here, phase retardation value R0 within a plane of a plate having phase retardation made of a film of stretched resin is measured using the above described “KOBRA-21ADH.”

(2) Phase Retardation Value R′ in Direction of Thickness

Phase retardation value R₀ within a plane, phase retardation value R₄₀ measured by inclining the delay phase axis by 40 degrees as an inclined axis, thickness d of the coating layer and average index of refraction n₀ of the coating layer are used to find nₓ, n_{y} and n_{z} in accordance with the method shown above, and then, phase retardation value R′ in the direction of the thickness is calculated in accordance with the above described formula (11).

(3) Adhesiveness

A compound polarizing plate is cut into such a size as to have a width of 25 mm and a length of approximately 250 mm with the optical transmission axis of the polarizer as the long side and then pasted to liquid crystal cell glass, and after that, a pressurizing process is carried out using an autoclave under pressure of 5 kgf/cm² at a temperature of 50° C. for 20 minutes. Next, the adhesiveness is measured under conditions of removal at 180° and a pulling rate of 300 mm/minute using a measuring machine “Autograph AG-1,” made by Shimadzu Corporation.

### Example 1

(a) Preparation of Plate with Coating Having Phase Retardation

The following components-are mixed and filtered with a membrane filter of which the pore diameter is 6 μm.

urethane resin varnish “SBU Lacquer 0866”: 7.5 parts

organic modified clay complex “Lucentite STN”: 6.8 parts

toluene: 85.7 parts

0.3 parts of “Lucentite SWN,” which is an unmodified clay mineral, were added as an adsorbent, and the mixture was stirred for 120 minutes, and after that, filtered with a membrane filter of which the pore diameter is 6 μm, and thus, a coating liquid was prepared. The content concentration of this coating liquid was 9%, and the weight ratio of the solid of the organic modified clay complex/urethane resin was 3/1. This coating liquid was applied to a polyethylene terephthalate film (angle of contact of mold release processed surface with water: 110°) having a thickness of 38 μm on which a mold release process was carried out using an applicator, and after that, dried for one minute at 50° C. and then for three minutes at 90° C., and thus, a plate having phase retardation that is coated on a film was gained. The phase retardation value of this coating layer was R₀=0 nm and R′=123 nm.

(b) Preparation of Compound Polarizing Plate

A polarizing plate (trade name “Sumikalan SRW842A,” sold by Sumitomo Chemical Co., Ltd.) having a protective layer on the two sides of a polyvinyl alcohol-iodine based polarizer and an adhesive layer attached to one side was pasted to the plate having phase retardation gained in the above described (a) so that the adhesive side of the polarizer made contact with the exposed surface of the coating layer, and thus, a half finished product made of a polarizing plate/adhesive layer/coating layer/mold release film was prepared. Furthermore, a separate polyethylene terephthalate film where an adhesive is applied to the mold release processed surface was pasted to the surface of the coating layer after the mold release film was removed, in such a manner that the adhesive side of the film made contact with the coating layer, and thus, a compound polarizing plate made of a polarizing plate/adhesive layer/coating layer/adhesive layer/mold release film was fabricated.

(c) Preparation and Evaluation of Liquid Crystal Display

The mold release film of the compound polarizing plate made of a polarizing plate/adhesive layer/coating layer/adhesive layer/mold release film gained in the above described (b) and the compound polarizing plate were layered on the upper surface of a VA type liquid crystal cell (commercially available) via the adhesive layer of the compound polarizing plate, while a second plate having phase retardation made of an stretched film of cyclic polyolefin where phase retardation value within a plane Ro =100 nm and phase retardation value in the direction of the thickness R′=130 nm was layered on the lower surface of the liquid crystal cell via an adhesive layer, and beneath this, a second polarizing plate (trade name “Sumikalan SQ0642A,” sold by Sumitomo Chemical Co., Ltd.) having a protective layer on one side of a polyvinyl alcohol/iodine based polarizer was layered via an adhesive in such a manner that the bottom layer on the lower side became a protective layer for the second polarizing plate, and thus, a liquid crystal display was prepared. Here, the angle formed between the absorbance axes of the compound polarizing plate and the second polarizing plate was 90°, and the angle formed between the absorbance axis of the second polarizing plate and the delay phase axis of the second plate having phase retardation was 90°. The adhesiveness of the compound polarizing plate immediately after being pasted to the upper surface of this liquid crystal display was 6.91 N/25 mm, and the adhesiveness one week of storage at 23° C. was 6.66 N/25 mm, and thus, 96% of the adhesiveness immediately after pasting was preserved.

### Example 2

(a) Preparation of Plate with Coating Having Phase Retardation

Urethane resin varnish “SBU Lacquer 0866,” organic modified clay complex “Lucentite STN” and toluene were mixed so as to have the same composition as in Example 1 and filtered with a membrane filter of which the pore diameter is 6 μm. 12.0 parts of “Duolite A161TRS04,” which is an anion exchange resin, were added to the mixed liquid after filtering as an adsorbent, and the mixture was stirred for 30 minutes, and after that, the mixed liquid was filtered with a membrane filter of which the pore diameter is 6 μm, so that a coating liquid was prepared. As a result of this filtering, the anion exchange resin was completely removed from the coating liquid. This coating liquid was applied to a polyethylene terephthalate film having a thickness of 38 μm on which a mold release process was carried out under the same conditions as in Example 1, and after that, dried, and thus, a plate having phase retardation which was coated on a film was gained. The phase retardation value of this coating value was R₀=0 nm and R′=113 nm.

(b) Preparation of Compound Polarizing Plate

The phase retardation plate gained in the above described (a) was used, and a half finished product made of a polarizing plate/adhesive layer/coating layer/mold release film was prepared in the same manner as in (b) of Example 1, and furthermore, a compound polarizing plate made of a polarizing plate/adhesive layer/coating layer/adhesive layer/mold release film was prepared.

(c) Preparation and Evaluation of Liquid Crystal Display

The compound polarizing plate made of a polarizing plate/adhesive layer/coating layer/adhesive layer/mold release film gained in the above described (b) was used, and a liquid crystal display was prepared in the same manner as in (c) of Example 1. The adhesiveness of the compound polarizing plate immediately after the compound polarizing plate was pasted to the upper surface of this liquid crystal display was 7.08 N/25 mm, and in addition, the adhesiveness after storage for one week at 23° C. was 6.07 N/25 mm, and thus, 86% of the adhesiveness immediately after pasting was preserved.

### Comparative Example 1

(a) Preparation of Plate with Coating Having Phase Retardation

Urethane resin varnish “SBU Lacquer 0866,” organic modified clay complex “Lucentite STN” and toluene were mixed so as to have the same composition as in Example 1 and filtered with a membrane filter of which the pore diameter is 6 μm, and thus, a coating liquid was prepared. In this example, no process using an absorbent was carried out. This coating liquid was applied to a polyethylene terephthalate film having a thickness of 38 μm on which a mold release process was carried out under the same conditions as in Example 1, and after that, dried, and thus, a plate having phase retardation which was coated on a film was gained. The phase retardation value of this coating value was R₀=0.1 nm and R′=126 nm.

(b) Preparation of Compound Polarizing Plate

The phase retardation plate gained in the above described (a) was used, and a half finished product made of a polarizing plate/adhesive layer/coating layer/mold release film was prepared in the same manner as in (b) of Example 1, and furthermore, a compound polarizing plate made of a polarizing plate/adhesive layer/coating layer/adhesive layer/mold release film was prepared.

(c) Preparation and Evaluation of Liquid Crystal Display

The compound polarizing plate made of a polarizing plate/adhesive layer/coating layer/adhesive layer/mold release film gained in the above described (b) was used, and a liquid crystal display was prepared in the same manner as in (c) of Example 1. The adhesiveness of the compound polarizing plate immediately after the compound polarizing plate was pasted to the upper surface of this liquid crystal display was 8.96 N/25 mm, and in addition, the adhesiveness after storage for one week at 23° C. was 3.01 N/25 mm, and thus, the adhesiveness lowered to 34% of immediately after pasting was preserved.

It can be seen from the above described examples and comparative example that a coating liquid is processed with a clay mineral or an anion exchange resin according to the present invention, and thereby, a plate with a coating having phase retardation gained from the coating liquid after processing has excellent adhesiveness when it is pasted to liquid crystal cell glass via an adhesive.

According to a method of the present invention, a coating liquid for a plate with a coating having phase retardation can be manufactured, in which the adhesiveness of an adhesive, when a plate with a coating having phase retardation or a compound polarizing plate where a polarizing plate is layered on such a plate with a coating having phase retardation is pasted to the liquid crystal cell glass via the adhesive, can be prevented from lowering, and a plate with a coating having phase retardation, of which the adhesiveness to the liquid crystal cell glass is slightly lowered, as well as a compound polarizing plate can be manufactured using such a coating liquid. In addition, according to the method of the present invention, a coating liquid for a plate with a coating having phase retardation, where the content of an impurity that causes the adhesiveness of the adhesive to the liquid crystal cell glass to lower has been reduced, can be manufactured.

What is claimed is:

1. A manufacturing method for a coating liquid for a plate with a coating having phase retardation, the method comprising a step of mixing an organic solvent, an organic modified clay complex and a binder resin, and a step of adding an adsorbent which can remove an impurity included in the mixture.

2. The method according to claim 1, wherein the weight ratio of the organic modified clay complex/binder resin is more than 0.5 and not more than 4 in the mixture.

3. The method according to claim 1, wherein the binder resin is a urethane resin having a base of isophorone diisocyanate.

4. The method according to any of claims 1 to 3, wherein the organic modified clay complex is a complex of a quaternary ammonium compound having an alkyl group of 1 to 30 of carbon number and a clay mineral belonging to a smectite group.

5. The method according to claim 1, wherein the adsorbent is selected from clay minerals belonging to a smectite group, and anion exchange resins.

6. The method according to claim 1, wherein the method further comprises a step of filtering using a filter after the step of adding an adsorbent for processing.

7. A manufacturing method for a plate with a coating having phase retardation, the method comprising a step of mixing an organic solvent, an organic modified clay complex and a binder resin, a step of adding an adsorbent which can remove an impurity included in the mixture, a step of applying the obtained coating liquid to a base, and a step of drying it.

8. A manufacturing method for a compound polarizing plate, the method comprising a step of mixing an organic solvent, an organic modified clay complex and a binder resin, a step of adding an adsorbent which can remove an impurity included in the mixture, a step of applying the obtained coating liquid to a transfer base, a step of drying it to form a plate with a coating having phase retardation, a step of pasting a polarizing plate having an adhesive layer to an exposed surface of the plate with a coating having phase retardation on the adhesive layer side, and a step of removing the transfer base from said plate with a coating having phase retardation.
